(19) United States
(12) Patent Application Publication
(10) Pub. No.: US 2006/0013745 A1
(43) Pub. Date: Jan. 19, 2006

(54) Enhanced PFC waste-gas treating system

(76) Inventor: Yi-Rong Chen, Taipei County (TW)

Correspondence Address: BACON & THOMAS, PLLC, 625 SLATERS LANE, FOURTH FLOOR, ALEXANDRIA, VA, 22314, US

(21) Appl. No.: 10/892,184

(22) Filed: Jul. 16, 2004

(51) Int. Cl. B01D 53/34; B01D 50/00

(52) U.S. Cl. 422/168

(57) ABSTRACT

The waste-gas treating system is designed for treating the waste gas created in general semiconductor processing in production; the waste-gas treating system mainly is provided at one side of a waste-gas treating equipment, and contains therein mainly a condensing tube, a catalyst treating unit, a water treating unit and water collecting tanks; the catalyst treating unit decomposes toxic gases such as per-fluorine compound (PFC) etc. that are remained in the waste-gas treating equipment and are unable to be dealt with to thereby form non-toxic gases, and does water treating on the byproduct from dissociation, thus a function of lowering temperature can be acquired, then the gases are exhausted to the atmosphere to perform secondarily treating to reduce the content of PFC in the atmosphere and to reduce damage of the hothouse effect.

### BACKGROUND OF THE INVENTION

1. Field of the Invention

The present invention is related to an enhanced PFC waste-gas treating system, and especially to a waste-gas treating system designed for treating the waste gases created in general semiconductor processing in production; the waste-gas treating system mainly is provided at one side of a waste-gas treating equipment, and is used to secondarily treat the residual gases containing PFC (per-fluorine compound), so that the gases containing PFC can be totally decomposed, and thereby the gases will not make damage to the environment or human bodies during exhausting the gases to the atmosphere.

2. Description of the Prior Art

Whereas the industry of semiconductor (including high-tech electric elements such as microprocessors, memories, integrated circuits . . . etc.) have really been the center of development of the modern industry; however, the industry of semiconductor needs to use large amount of water, electricity and dangerous as well as harmful chemical materials.

Particularly in the process of production, large amount of dangerous and harmful chemical agents such as methyl triethoxy silicane (TEOS), hydrofluoride acid (HF), nitrogen oxide (NO_{X}), hydrogen phosphide (PH₃), hydrogen arsenide (AsH₃) and (per-fluorine compound) PFC etc. Wherein if the toxic substance (per-fluorine compound) PFC such as nitrogen trifluoride (NF₃), sulfur hexafluoride (SF₆), carbon tetrafluoride (CF₄), C₃F₈ and C₂F₆ etc. is not well treated and is exhausted to the atmosphere, it not only pollutes the environment, but also makes enlargement of the hothouse effect.

Thereby in the process of production, a waste-gas treating equipment 1 must be used to treat toxic gases created after production. Referring to FIG. 1, conventional waste-gas treating equipments are divided into two kinds: the single type treating equipments and the composite treating equipments. The single type treating equipments include the thermoelectric type, the water cleansing type, the plasma type, the adsorption type and the combustion type; the composite treating equipments mainly are combinations each of more than two single type treating equipments, such as a composite treating equipment composed of a thermoelectric type plus a water cleansing type, or a thermoelectric type plus a water cleansing type and an adsorption type etc.

However, no matter a treating equipment belongs to the single type treating equipments (water cleansing type) or the composite treating equipments (a thermoelectric type plus a water cleansing type), it is unable to have the per-fluorine compound (PFC) contained in waste gases created during the process of production been effectively treated for removing, and a singular catalyst type equipment is unable to effectively treat other waste gases created during the process of semiconductor production, it can not be widely used to treat waste gases of semiconductor industry.

Thereby, the waste-gas treating system of the present invention can be connected with a composite treating equipment (a thermoelectric type plus a water cleansing type), the composite treating equipment can have the waste gases created during the process of semiconductor production other than PFC, and then the waste-gas treating system of the present invention is used to effectively treat the per-fluorine compound (PFC) contained in waste gases that the composite treating equipment (a thermoelectric type plus a water cleansing type) is unable to effectively remove in the former stage.

Therefore, the waste-gas treating system of the present invention can treat per-fluorine compound (PFC) that the composite treating equipment (a thermoelectric type plus a water cleansing type) is unable to effectively remove, and can be widely used to treat waste gases of the semiconductor industry.

### SUMMARY OF THE INVENTION

In view of the above statement, the inventor of the present invention developed successfully an enhanced PFC waste-gas treating system based on his professional experience of years in studying, designing and manufacturing as well as after hard study and development.

Thereby, the enhanced PFC waste-gas treating system of the present invention mainly is provided at one side of a waste-gas treating equipment, and is used to secondarily treat the residual gases containing PFC (per-fluorine compound) after treating by the waste-gas treating equipment, so that the gases containing PFC can be totally decomposed, and thereby the gases will not make environmental pollution during exhausting the gases outside, and can effectively prevent enlargement of the hothouse effect. The system contains therein mainly a condensing tube, a catalyst treating unit, a water treating unit and water collecting tanks, the catalyst treating unit decomposes toxic gases such as per-fluorine compound (PFC) etc. to form non-toxic gases, and the byproduct from decomposing is subjected to water treating by means of the water treating unit, thus a function of lowering temperature can be acquired, then the gases are exhausted to the atmosphere to lower the damage of pollution of the semiconductor industry to the environment.

The object of the present invention is: by condensing of the condensing tube in a front section to deal with the water vapor created by the composite treating equipment (a thermoelectric type plus a water cleansing type), the resulted material enters the catalyst treating unit having therein gas of per-fluorine compound (PFC) to keep it dry, and the catalyst treating unit dissociates the gases containing the per-fluorine compound (PFC), and the byproduct created by dissociation when entering the water treating unit is converted into gases not harmful to human bodies. And a function of lowering temperature can be acquired; then the gases are exhausted to the atmosphere to lower the damage of pollution of the semiconductor industry to the environment.

The present invention will be apparent in its content and effects to be achieved after reading the detailed description of the preferred embodiment thereof in reference to the accompanying drawings.

### BRIEF DESCRIPTION OF THE DRAWINGS

FIG. 1 is a schematic perspective view of a conventional waste-gas treating equipment;

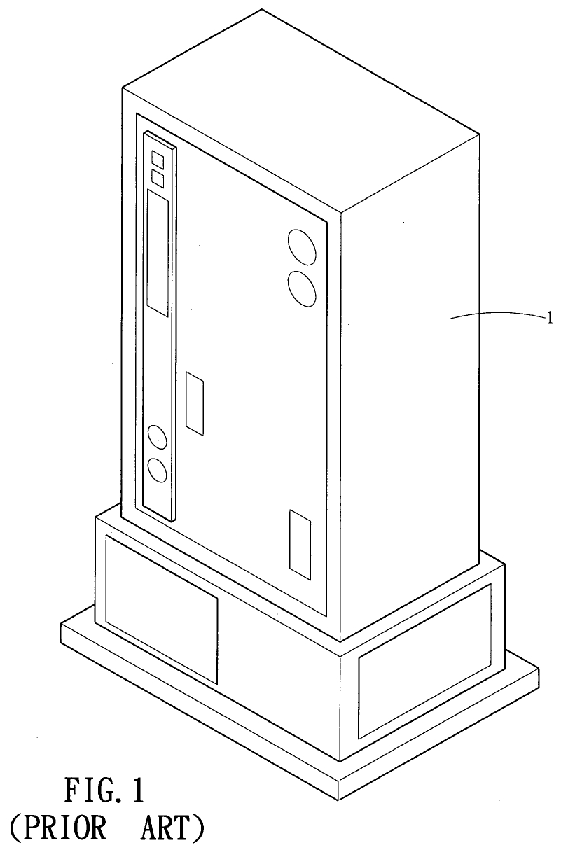

FIG. 2 is a schematic perspective view showing application of the present invention;

FIG. 3 is a perspective view of the present invention;

FIG. 4 is a schematic sectional view of the present invention.

### DETAILED DESCRIPTION OF THE PREFERRED EMBODIMENT

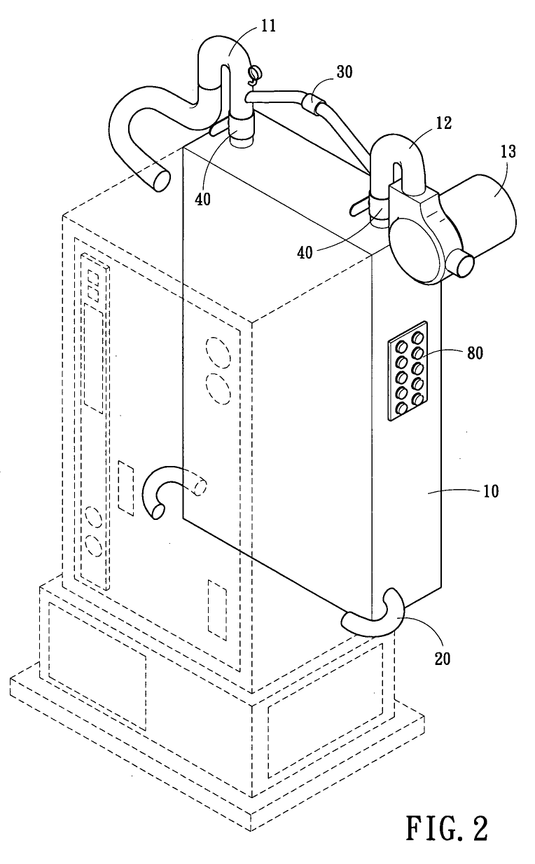

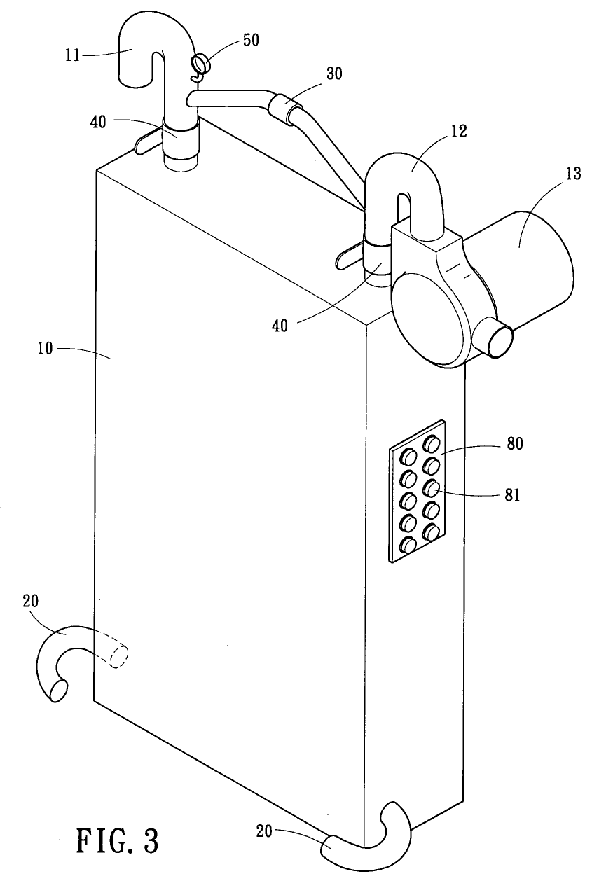

The enhanced PFC waste-gas treating system of the present invention mainly is provided at one side of a waste-gas treating equipment 1, as shown in FIGS. 2 and 3, it comprises a machine main body 10, the machine main body 10 is provided exteriorly thereof with a gas inlet 11 and a gas exhausting tube 12; the gas inlet 11 is connected with the waste-gas treating equipment 1 to guide the gases exhausted from the latter, the gas exhausting tube 12 is connected with a gas drawing pump unit 13 to exhaust the gases in the machine main body 10.

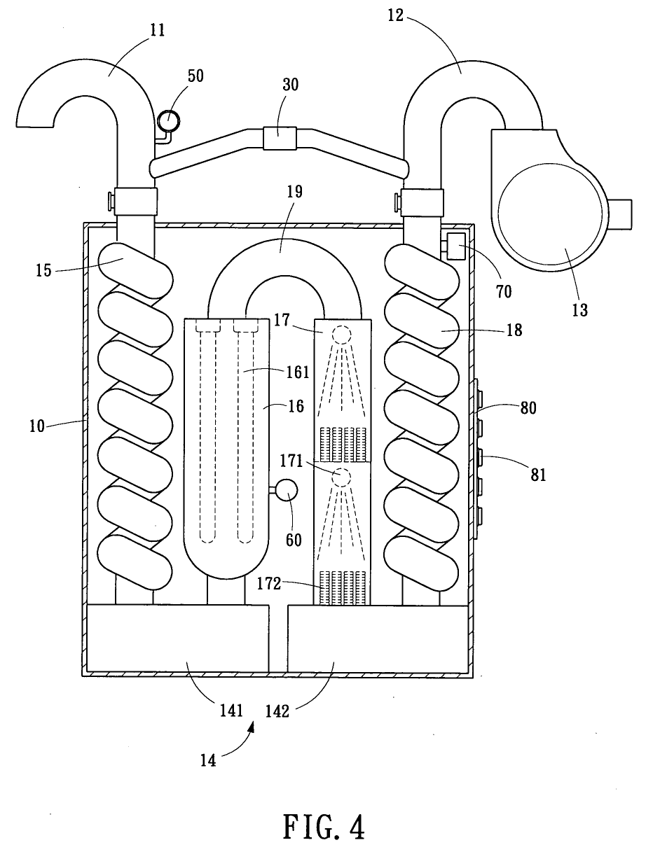

Referring simultaneously to FIG. 4, the machine main body 10 is provided therein further with two water collecting tanks 14, a front-section condensing tube 15, a catalyst treating unit 16, a water treating unit 17 and a rear-section condensing tube 18; wherein a first water collecting tank 141 is provided with the front-section condensing tube 15 and the catalyst treating unit 16, a second water collecting tank 142 is provided with the water treating unit 17 and the rear-section condensing tube 18. The catalyst treating unit 16 and the water treating unit 17 are connected with each other via a pipeline 19, the front-section condensing tube 15 is connected with the gas inlet 11 exteriorly of the machine main body 10, while the rear-section condensing tube 18 is connected with the gas exhausting tube 12 also exteriorly of the machine main body 10.

The catalyst treating unit 16 is provided therein with a catalyst tube 161, the water treating unit 17 is provided-therein with a water spraying pipe 171 and an adsorption element 172, and the first water collecting tank 141 and the second water collecting tank 142 are connected with the waste-gas treating equipment 1 respectively through guiding tubes 20.

Thereby, when the gases containing PFC (per-fluorine compound) such as NF₃, SF₆, and C₂F₆ etc. enters the machine main body 10 through the gas inlet 11 after treatment of the waste-gas treating equipment 1, the front-section condensing tube 15 converts the water vapor contained in the gas of per-fluorine compound (PFC) into the state of water solution to stay in the first water collecting tank 141, thereby the gases containing the per-fluorine compound (PFC) can keep dry and enter the catalyst treating unit 16, the gases containing the per-fluorine compound (PFC) (such as NF₃, SF₆, and C₂F₆ etc.) is dissociated by the catalyst tube 161 in the catalyst treating unit 16, the chemical equation of this is as follows:
NF₃→HF+F₂+NO_{X}
SF₆→HF+F₂+SO_{X}
C₂F₆→HF+F₂+CO₂

Then the gases after dissociation are led by the pipeline 19 into the water treating unit 17, by virtue that the water treating unit 17 is provided therein with the water spraying pipe 171 and the adsorption element 172 (in the embodiment of the present invention, the water treating unit 17 is divided into an upper and a lower layer, each of these layers is provided with the water spraying pipe 171 and the adsorption element 172), so that an operation of water sprinkling can be performed by means of the water spraying pipe 171 to do water treating on the gas byproducts such as HF, F₂, NO_{X}, SO_{X}, SiF₄ etc., and to make their temperature lower, the chemical equation of this is as follows:
HF(g)→HF(ag)
F₂+H₂O→HF(ag)+O₂

The gases obtained after dissociation by the catalyst treating unit 16, such as the gases HF, F₂, SiF₄ etc., are again converted into non-toxic gases such as HF (ag), 0₂ etc. by the water treating unit 17, then the non-toxic gases and water are led into the second water collecting tank 142, lastly, water vapor is dealt with by the rear-section condensing tube 18, and the gas drawing pump unit 13 is used to discharge the non-toxic gases to the atmosphere via the gas exhausting tube 12, hence the gases exhausted will not be harmful to the environment and human bodies.

As stated above, by virtue that the water treating unit 17 is provided therein with the adsorption element 172, and the adsorption element 172 is made of ceramic material (i.e., a Raschig ring), so that the contact area of water with gases such as HF, F₂, SiF₄ etc. obtained after dissociation and detaining time of them can be increased by the aid of the adsorption element 172, so that the gases such as HF, F₂, SiF₄ etc. obtained after dissociation can be completely decomposed to form non-toxic gases in the water treating unit 17.

And more, referring to FIGS. 2 to 4, wherein the gas inlet 11 and the gas exhausting tube 12 are connected therebetween with a pneumatic valve 30 which is shut in normal use, while the gas inlet 11 and the front-section condensing tube 15, the gas exhausting tube 12 and the rear-section condensing tube 18 are both connected therebetween with a manually valve 40 which is in an opened stated in normal use. Thereby, when the interior of the machine main body 10 is out of order or when it is in maintenance or changing the catalyst tube 161, the passageways between the gas inlet 11 and the front-section condensing tube 15 as well as between the gas exhausting tube 12 and the rear-section condensing tube 18 can be cut short by means of the manually valve 40, the gases are forced to be led to the gas exhausting tube 12 via the pneumatic valve 30 for exhausting to avoid damage of the interior of the machine main body 10.

The gas inlet 11 is provided on the outer surface thereof with a pressure detector 50 to detect the inner pressure of the gas inlet 11; and the catalyst treating unit 16 is provided on the outer surface thereof with a temperature sensor 60 to detect the inner temperature of the catalyst treating unit 16, thereby to avoid damage of the catalyst treating unit 16 because of overly high temperature induced in the catalyst treating unit 16. And the rear-section condensing tube 18 is provided on the outer surface thereof with a gas detector 70 to detect whether there are residual gases containing per-fluorine compound (PFC), in order to maintain normal operation of the whole waste-gas treating system.

Moreover, a control unit 80 is provided on the outer wall of the machine main body 10, the control unit 80 is further provided with a plurality of control buttons 81 to control components in the machine main body 10, thereby the entire waste-gas treating system can be more convenient in use.

The names of the members are only for illustrating a preferred embodiment of the present invention, and not for giving any limitation to the scope of the present invention. It will be apparent to those skilled in this art that various equivalent modifications or changes made to the present invention without departing from the spirit thereof shall fall within the scope of the appended claims.

1. An enhanced PFC waste-gas treating system provided at one side of a waste-gas treating equipment, said system comprises:
a machine main body, said machine main body is provided exteriorly thereof with a gas inlet and a gas exhausting tube; said gas inlet is connected with said waste-gas treating equipment; said gas exhausting tube is connected with a gas drawing pump unit to exhaust gases in said machine main body; said machine main body is provided therein further with two water collecting tanks, a front-section condensing tube, a catalyst treating unit, a water treating unit and a rear-section condensing tube; wherein a first water collecting tank is provided with said front-section condensing tube and said catalyst treating unit, a second water collecting tank is provided with said water treating unit and said rear-section condensing tube; said catalyst treating unit and said water treating unit are connected with each other via a pipeline, said front-section condensing tube is connected with said gas inlet exteriorly of said machine main body, while said rear-section condensing tube is connected with said gas exhausting tube also exteriorly of said machine main body.

2. The enhanced PFC waste-gas treating system as claimed in claim 1, wherein said catalyst treating unit is provided therein with a catalyst tube.

3. The enhanced PFC waste-gas treating system as claimed in claim 1, wherein said water treating unit is provided therein with a water spraying pipe and an adsorption element.

4. The enhanced PFC waste-gas treating system as claimed in claim 3, wherein said water treating unit is divided into an upper and a lower layer, each of said layers is provided with a set of said water spraying pipe and said adsorption element.

5. The enhanced PFC waste-gas treating system as claimed in claim 3, wherein said adsorption element is made of ceramic material.

6. The enhanced PFC waste-gas treating system as claimed in claim 1, wherein said first water collecting tank and said second water collecting tank are connected with said waste-gas treating equipment each through a guiding tube to lead collected water into said waste-gas treating equipment.

7. The enhanced PFC waste-gas treating system as claimed in claim 1, wherein said gas inlet and said gas exhausting tube are connected therebetween with a pneumatic valve; while said gas inlet and said front-section condensing tube, said gas exhausting tube and said rear-section condensing tube are both connected therebetween with a manually valve, thereby, when the interior of said machine main body is out of order or when it is in maintenance or changing said catalyst tube, passageways between said gas inlet and said front-section condensing tube as well as between said gas exhausting tube and said rear-section condensing tube are cut short by means of said manually valve, gases are forced to be led to said gas exhausting tube via said pneumatic valve for exhausting to avoid damage of said interior of said machine main body.

8. The enhanced PFC waste-gas treating system as claimed in claim 1, wherein said gas inlet is provided on an outer surface thereof with a pressure detector to detect inner pressure of said gas inlet.

9. The enhanced PFC waste-gas treating system as claimed in claim 1, wherein said catalyst treating unit is provided on an outer surface thereof with a temperature sensor to detect inner temperature of said catalyst treating unit.

10. The enhanced PFC waste-gas treating system as claimed in claim 1, wherein said rear-section condensing tube is provided on an outer surface thereof with a gas detector to detect whether there are residual gases containing per-fluorine compound (PFC) being not completely dissociated.

11. The enhanced PFC waste-gas treating system as claimed in claim 1, wherein a control unit is provided on one side of said machine main body to control components in said machine main body.

12. The enhanced PFC waste-gas treating system as claimed in claim 11, wherein said control unit is further provided with a plurality of control buttons.
